(19) United States
(12) Patent Application Publication
(10) Pub. No.: US 2019/0139174 A1
(43) Pub. Date: May 9, 2019

(54) SYSTEMS AND METHODS FOR AUTOMATING DELIVERY PRIORITIZATION AT A DISTRIBUTION CENTER

(71) Applicant: Walmart Apollo, LLC, Bentonville, AR (US)

(72) Inventors: Jeffrey Alan Ward, Casa Grande, AZ (US); Jacob R. Schrader, Sterling, IL (US); Andrew B. Millhouse, Gilbert, AZ (US)

(21) Appl. No.: 16/178,464

(22) Filed: Nov. 1, 2018

Related U.S. Application Data
(60) Provisional application No. 62/581,985, filed on Nov. 6, 2017.

(51) Int. Cl. G06Q 50/28; G06Q 10/06; G06K 7/10; G06K 19/07

(52) U.S. Cl. CPC G06Q 50/28; G06Q 10/06316; G06K 2019/06253; G06K 19/0723; G06K 7/10297

(57) ABSTRACT

In some embodiments, apparatuses and methods are provided herein useful to automating delivery prioritization at a distribution center. In some embodiments a system comprises a trailer seal, wherein the trailer seal includes an RFID tag, an RFID reader, wherein the RFID reader is located at the distribution center, a display device, and a control circuit configured to receive, from a vendor, shipment information for a delivery, associate, with the trailer seal, the delivery, receive, an identifier of the RFID tag, generate, the unique code, cause the display device to present the unique code to a mobile device, receive, from the mobile device, an identifier of the mobile device, associate, based on the identifier and the unique code, the delivery with the mobile device, determine, based on the shipment information, instructions for the delivery, and transmit, to the mobile device, the instructions for the delivery.

### CROSS-REFERENCE TO RELATED APPLICATION

This application claims the benefit of U.S. Provisional Application No. 62/581,985, filed Nov. 6, 2017, which is incorporated by reference in its entirety herein.

### TECHNICAL FIELD

This invention relates generally to retail supply chain and, more particularly, to automating retail supply chain.

### BACKGROUND

Distribution centers can be extremely hectic places. A large number of trucks and trailers enter and leave distribution centers, oftentimes constantly twenty-four hours per day. Managing and organizing this volume of traffic can be quite difficult. Typically, distribution centers rely on the exchange of physical documents (e.g., paper records) to keep track of deliveries. Additionally, distribution centers manually prioritize the deliveries. Because the volume is so high, it is difficult, if not impossible, for a person to manually prioritize the deliveries in an efficient manner at all times. Consequently, a need exists for systems, methods, and apparatuses which can automate delivery prioritization at a distribution center.

### BRIEF DESCRIPTION OF THE DRAWINGS

Disclosed herein are embodiments of systems, apparatuses, and methods pertaining to automating delivery prioritization at a distribution center. This description includes drawings, wherein:

FIG. 1 depicts a trailer 104 entering a distribution center 102, according to some embodiments;

FIG. 2 depicts a system 200 for automating delivery prioritization at a distribution center, according to some embodiments; and

FIG. 3 is a flow chart depicting example operations for automating delivery prioritization at a distribution center, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, and methods are provided herein useful to automating delivery prioritization at a distribution center. In some embodiments, a system comprises a trailer seal, wherein the trailer seal includes an RFID tag, and wherein the trailer seal is configured to be affixed to a trailer to prevent unauthorized access to the trailer, an RFID reader, wherein the RFID reader is located at the distribution center and configured to read RFID tags, a display device, wherein the display device is configured to present a unique code, and a control circuit communicatively coupled to the RFID reader, wherein the control circuit is configured to receive, from a vendor, shipment information for a delivery, associate, with the trailer seal, the delivery, receive, from the RFID reader, an identifier of the RFID tag, generate, based on the identifier of the RFID tag, the unique code, wherein the unique code allows physical access to the distribution center, cause the display device to present the unique code to a mobile device, wherein the mobile device is in possession of an individual associated with the trailer, receive, from the mobile device, an identifier of the mobile device, associate, based on the identifier and the unique code, the delivery with the mobile device, determine, based on the shipment information, instructions for the delivery, and transmit, to the mobile device, the instructions for the delivery.

As previously discussed, distribution centers typically keep track of deliveries via physical documents and prioritize deliveries manually. For example, upon arrival at a distribution center, a truck driver will check in and provide, to an employee at the distribution center, paperwork detailing his or her delivery (e.g., information about his or her shipment). The employee then provides the driver with new paperwork, possibly including information about the distribution center. Next the driver provides the new paperwork, along with the original paperwork, to another employee at the distribution center. This employee reviews all deliveries that have arrived, as well as those scheduled to arrive, and makes priority determinations. At a busy distribution center, where a truck arrives every four to six minutes twenty four hours per day, it is easy to see how manual determination of unloading priority will not yield the most efficient or best prioritization. This lack of efficient prioritization can result in perishable items becoming non-saleable, items not being restocked before they are sold out, and scheduling delays for arriving and departing trucks. These problems, as well as others resulting from inefficient prioritization, can cost retailers money, as well as time.

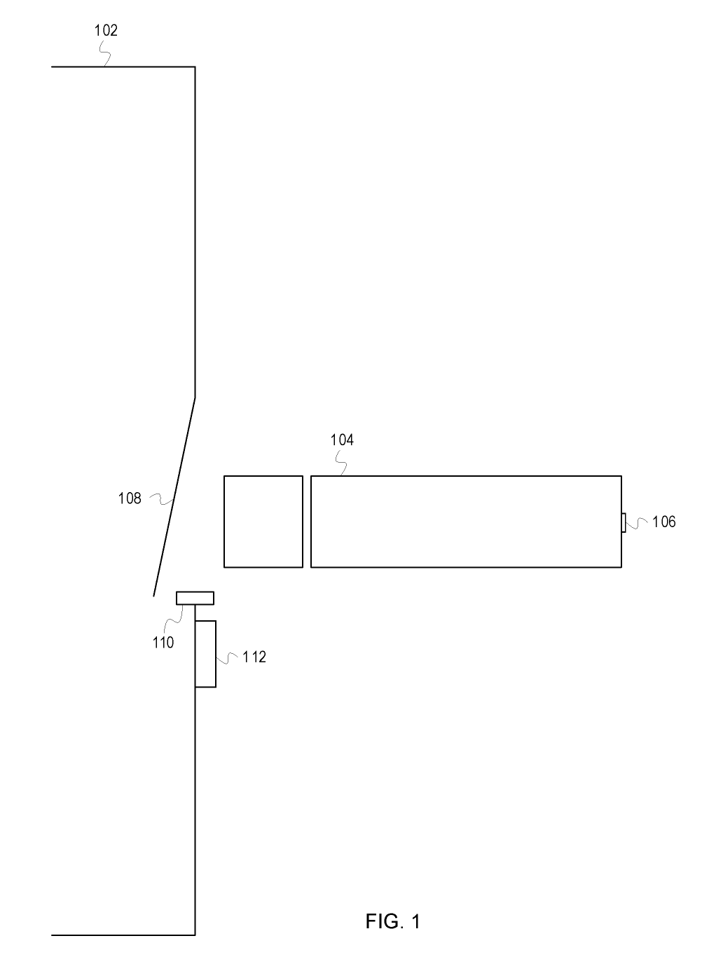

Embodiments of the inventive subject matter seek to improve the prioritization of deliveries through the use of automation. In some embodiments, trailer seals including RFID tags are utilized to identify trucks (i.e., deliveries hauled by the trucks). Distribution centers include RFID readers. When the truck enters the distribution center, the RFID readers read the RFID tags of the trailer seals, thus notifying distribution center personnel that a delivery has arrived. When the truck arrives, the system can make a priority determination based, for example, on the contents of the delivery, deliveries that have arrived, and deliveries that are scheduled to arrive. In some embodiments, the system can also associate a delivery with a mobile device carried, for example, by the driver. In such embodiments, the system can transmit instructions for the delivery (e.g., based on the priority determination) to the driver. The discussion of FIG. 1 provides additional detail regarding such a system.

FIG. 1 depicts a trailer 104 entering a distribution center 102, according to some embodiments. The trailer 104 contains a shipment (i.e., a “delivery”), at least a portion of which will be unloaded at the distribution center 102. The trailer 104 employs the use of a trailer seal 106 to prevent unauthorized access to the trailer 104. The trailer seal 106 can prevent unauthorized access physically (e.g., by employing a locking mechanism) or prevent unauthorized access by providing an indication of unauthorized access (e.g., via a tamper-evident mechanism), or in some embodiments, both. The trailer seal 106 includes an RFID tag. The RFID tag has an identifier (i.e., the identifier of the RFID tag). This identifier of the RFID tag can be used to identify the trailer 104, and thus the delivery.

The distribution center 102 includes a passageway, whether physical (e.g., marked by a physical boundary, such as a movable barrier or opening in a fence) or virtual (i.e., not marked by a physical boundary). In the example provided in FIG. 1, the passageway is depicted as a gate 108. As the trailer 104 passes through the gate 108, an RFID reader 110 reads the RFID tag. The RFID reader 110 is located at the distribution center 102. For example, the RFID reader 110 can affixed to, or otherwise located near, the gate 108, within the confines of the distribution center 102, or, as depicted in FIG. 1 in a position such that the RFID tag will be read before the trailer 104 passes through the gate 108.

Detection of the RFID tag by the RFID reader 110 alerts the system that the delivery has arrived and prompts retrieval of shipment information for the delivery. The shipment information can include an indication of items in the delivery, an indication of a retailer, an anticipated arrival date, an anticipated arrival time, an indication of a destination, etc. The system uses this information to determine instructions for the delivery. The instructions for the delivery provide information to the driver concerning where he or she should take delivery and what he or she should do while there. The instructions for the delivery can include a map of the distribution center, a dock number at which the trailer 104 should be delivered, a time at which the trailer 104 should be delivered, a location to which the trailer 104 should proceed, etc. For example, the delivery instructions can inform the driver that he or she should proceed to Dock 3 for unloading, include a map indicating a path to Dock 3, a time at which the driver should arrive at Dock 3, and instructions to leave the trailer 104 attached to the cab and chock the wheels.

In some embodiments, the instructions for delivery are based on a priority determination. The priority determination can take into account any number of factors, such as perishability of cargo, stock levels, previous sales, expected sales, expected arrival time of deliveries, vacancies in the distribution center, etc. For example, if the trailer 104 is carrying perishable items, unloading the trailer 104 may be a higher priority than unloading a trailer 104 containing clothing items. As another example, during the holiday season, if the trailer 104 is carrying popular toys, it may be given a higher priority than a trailer 104 carrying food items. Further, the priority determination may consider factors other than the contents of the trailer 104. For example, if the only delivery dock currently available is far from a refrigerated area and a dock near the refrigerated area is expected to be available soon, a delivery of nonperishable items may be given priority over a delivery of perishable items so that the delivery of perishable items can be unloaded near the refrigerated section. Additionally, in some embodiments, the priority determination can be based on considerations other than environmental factors. As one example, the priority determination can be based on temporal factors, such that a delivery that arrives early may be given lower priority than a delivery that has arrived on time.

In some embodiments, as depicted in FIG. 1, the system can also include a display device 112. The display device 112 can be used to present the instructions for the delivery to the driver. Additionally, or alternatively, in some embodiments, the display device 112 can be used to assist in associating the trailer 104 (i.e., the delivery) with a mobile device carried by the driver. The mobile device can be any device capable of interacting with the system, such a mobile phones, tablets, in-truck electronics (e.g., infotainment systems), computers, etc. In this manner, the system can transmit the instructions for delivery directly to the driver via the mobile device. For example, the system can generate, and the display device 112 can present, a unique code. The unique code can be presented in human-readable text (e.g., letters, numbers, symbols, etc.) or presented for scanning by the mobile device (e.g., a barcode or wireless transmission). Further, in some embodiments, the display device 112 can present the unique code audibly. The system generates the unique code in response to reading the RFID tag.

After receiving the unique code, the mobile device transmits the unique code to the system. This transmission includes an identifier of the mobile device (e.g., a phone number, PIN, etc.). Because the RFID tag is associated with the delivery and the unique code is generated based on the delivery, receipt of the unique code allows the system to associate the mobile device with the delivery. Once the mobile device is associated with the delivery, the system can transmit instructions for the delivery, as well as any other desired information, to the driver via the mobile device.

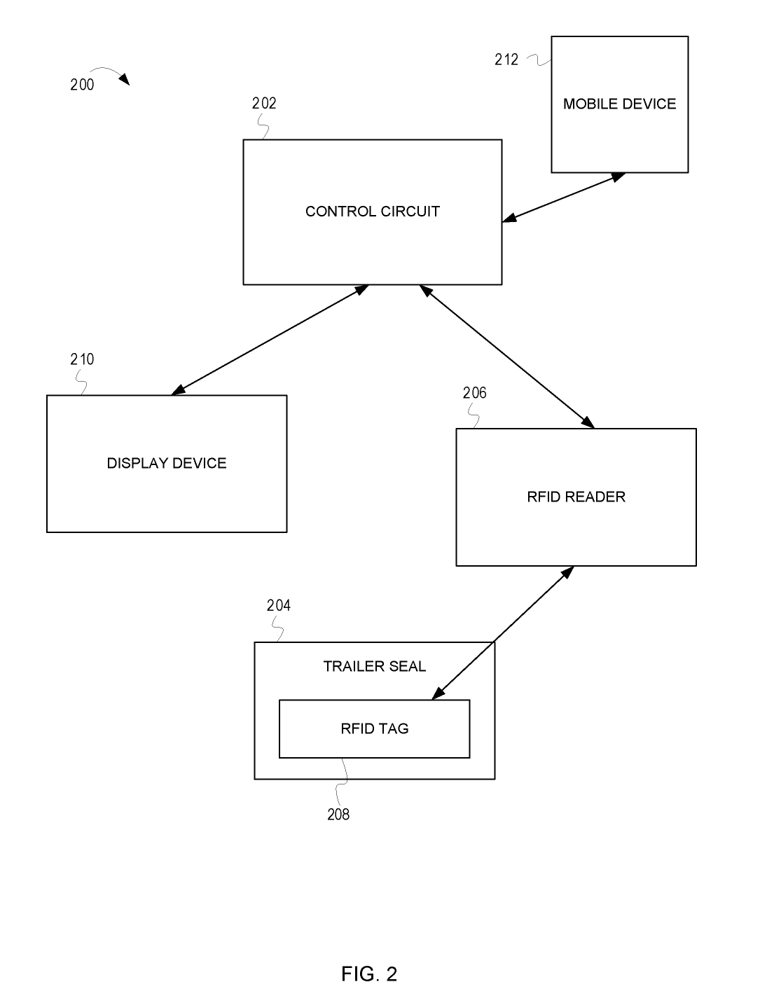

While the discussion of FIG. 1 provides background information regarding a system for automating delivery prioritization at a distribution center, the discussion of FIG. 2 provides additional details regarding such a system.

FIG. 2 is a system 200 for automating delivery prioritization at a distribution center, according to some embodiments. The system 200 includes a control circuit 202, a display device 210, an RFID reader 206, and a trailer seal 204. The control circuit 202 can be communicatively coupled to one or more of the mobile device 212, the display device 210, and the RFID reader 206. The control circuit 202 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 202 is configured (for example, by using corresponding programming as will be well understood by those skilled in the art) to carry out one or more of the steps, actions, and/or functions described herein.

By one optional approach the control circuit 202 operably couples to a memory. The memory may be integral to the control circuit 202 or can be physically discrete (in whole or in part) from the control circuit 202 as desired. This memory can also be local with respect to the control circuit 202 (where, for example, both share a common circuit board, chassis, power supply, and/or housing) or can be partially or wholly remote with respect to the control circuit 202 (where, for example, the memory is physically located in another facility, metropolitan area, or even country as compared to the control circuit 202).

This memory can serve, for example, to non-transitorily store the computer instructions that, when executed by the control circuit 202, cause the control circuit 202 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

Before a delivery is dispatched, the control circuit 202 can associate the delivery with an RFID tag 208 associated with the trailer seal 204. In some embodiments, the retailer leases the trailer seal 204 to a vendor (e.g., a third party, distributor, manufacturer, etc.). In such embodiments, the retailer may know which trailer seals 204 are possessed by the third party and which are available for use. In such embodiments, the retailer can instruct the third party to use a specific trailer seal 204. Alternatively, the third party can select a trailer seal 204 to use and inform the retailer of which trailer seal 204 will be used. The third party can also provide the retailer with shipment information for the delivery. The control circuit 202 associates delivery with the trailer seal 204 (i.e., the RFID tag 208). For example, the control circuit can associate the trailer seal 204 with a shipment number, order number, etc. for easy retrieval of the information for the delivery.

When the delivery arrives at the distribution center, the RFID reader 206 reads the RFID tag 208 associated with the trailer seal 204. The RFID reader 206 transmits an identifier of the RFID tag 208 to the control circuit 202. Upon receipt of the identifier of the RFID tag 208, the control circuit 202 generates a unique code. The unique code allows the control circuit 202 to associate the delivery with the mobile device 212. In some embodiments, the control circuit 202 causes the display device 210 to present the unique code. The driver then enters and/or scans the unique code via the mobile device 212 and transmits the unique code to the control circuit 202. This transmission includes an identifier of the mobile device 212 (e.g., a telephone number, IP address, MAC address, etc.), allowing the control circuit 202 to associate the delivery with the mobile device 212. After determining instructions for the delivery, the control circuit 202 transmits the instructions for the delivery to the mobile device 212.

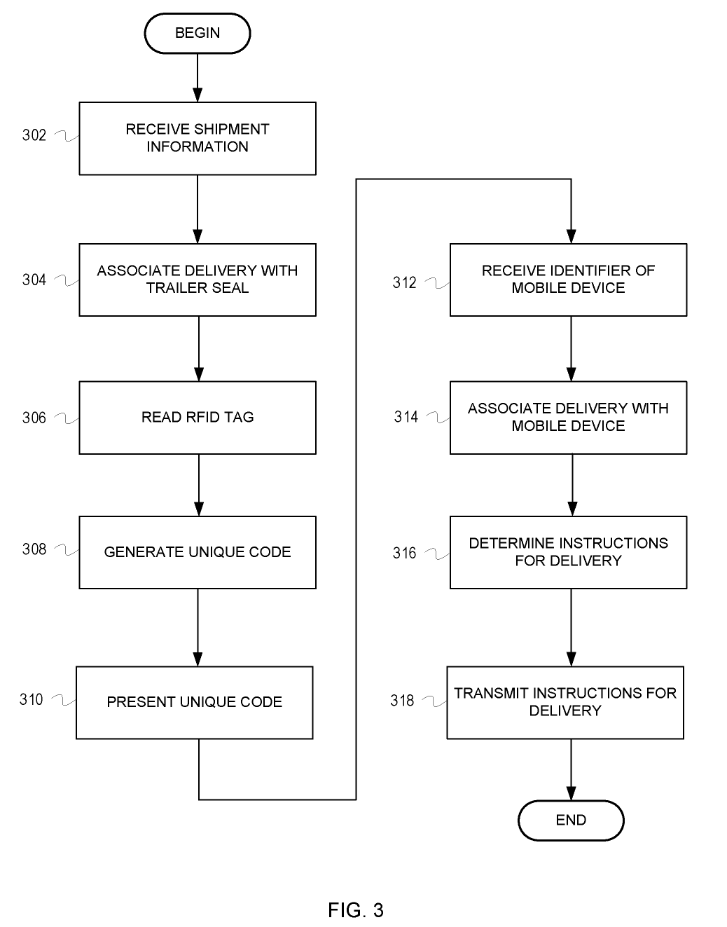

While the discussion of FIG. 2 provides additional details regarding a system for automating delivery prioritization at a distribution center, the discussion of FIG. 3 describes example operations for automating delivery prioritization at a distribution center.

FIG. 3 is a flow chart depicting example operations for automating delivery prioritization at a distribution center, according to some embodiments. The flow begins at block 302.

At block 302, shipment information for a delivery is received. For example, a control circuit can receive shipment information from a vendor (i.e., a party delivering the delivery). The shipment information can include an indication of items in the delivery, an indication of a retailer, an anticipated arrival date, an anticipated arrival time, an indication of a destination, an indication of the vendor, or any other relevant information. The flow continues at block 304.

At block 304, the delivery is associated with a trailer seal. For example, the control circuit can associate the delivery with the trailer seal. In some embodiments, the retailer is aware of trailer seals held by the vendor. For example, the retailer can sell, lease, or give the trailer seals to the vendor. In such embodiments, the retailer can track which trailer seals are in use and which trailer seals are available for use. After determining which trailer seals are available for use, the retailer can assign a trailer seal to the vendor. The trailer seals can be configured for a single use or multiple uses. The trailer seal includes an RFID tag. The control circuit associates the trailer seal with the delivery by associated an identifier of the RFID tag with the delivery. The flow continues at block 306.

At block 306, the RFID tag is read. For example, an RFID reader located at a distribution center can read the RFID tag as a trailer to which the trailer seal is affixed arrives at or near the distribution center. The RFID reader reads the RFID tag by receiving an identifier of the RFID tag from the RFID tag. After reading the RFID tag, the RFID reader transmits the identifier of the RFID tag to the control circuit. The flow continues at block 308.

At block 308, a unique code is generated. For example, the control circuit can generate the unique code. In some embodiments, the control circuit generates the unique code before the RFID reader reads the RFID tag (e.g., when associating the delivery with the trailer deal). In other embodiments, the control circuit generates the unique code when the trailer arrives at the distribution center (e.g., in response to receiving the identifier for the RFID tag from the RFID reader). The unique code can be any suitable type of code, such as a numeric code, an alphabetic code, an alphanumeric code, a sound pattern, a wireless transmission, etc. The unique code allows the control circuit to associate the delivery with a mobile device. The mobile device can be carried by the driver. The flow continues at block 310.

At block 310, the unique code is presented. For example, the control circuit can cause a display device to present the unique code. The display device can present the unique code visibly, audibly, or via a wireless transmission to the mobile device (e.g., near field communication, Wi-Fi, etc.). In this regard, the display device can be any type of device suitable to present the unique code. Additionally, in some embodiments, the unique code can include address information for the control circuit. Alternatively, the address information may be known by the driver or the mobile device, or may be displayed elsewhere. The flow continues at block 312.

At block 312, an identifier of the mobile device is received. For example, the mobile device can transmit the identifier of the mobile device to the control circuit. In some embodiments, after receiving the unique code, the mobile device transmits the unique code (or any other identifiable message) to the control circuit. This message includes an identifier of the mobile device. For example, the message can include an explicit indication of the identifier for the mobile device, or the identifier for the mobile device may be included implicitly in the message (e.g., in metadata associated with the message). The flow continues at block 314.

At block 314, the delivery is associated with the mobile device. For example, the control circuit can associate the delivery with the mobile device based on the identifier of the mobile device and the unique code. The control circuit is able to associate the mobile device with the delivery based on the association between the unique code and the identifier for the RFID tag and the association between the identifier for the RFID tag and the delivery. The flow continues at block 316.

At block 316, instructions for the delivery are determined. For example, the control circuit can determine the instructions for the delivery. The instructions for the delivery can include a map of the distribution center, a dock number at which the trailer should be delivered, a time at which the trailer, a location to which the trailer should proceed, etc. In some embodiments, the delivery instructions are based on a priority determination. The priority determination can take into account any number of factors, such as perishability, stock levels, previous sales, expected sales, expected arrival time of deliveries, vacancies in the distribution center, etc. The flow continues at block 318.

At block 318, the instructions for the delivery are transmitted. For example, the control circuit can transmit the instructions for the delivery to the mobile device. The control circuit can transmit the instructions for the delivery to the mobile device in any suitable manner (e.g., via a wired or wireless transmission). Additionally, in some embodiments, if the instructions for the delivery are updated or changed, or additional instructions are needed, the control circuit can again transmit the instructions for the delivery to the mobile device.

Generally speaking, pursuant to various embodiments, systems, apparatuses, and methods are provided herein useful to automating delivery prioritization at a distribution center. In some embodiments, a system comprises a trailer seal, wherein the trailer seal includes an RFID tag, and wherein the trailer seal is configured to be affixed to a trailer to prevent unauthorized access to the trailer, an RFID reader, wherein the RFID reader is located at the distribution center and configured to read RFID tags, a display device, wherein the display device is configured to present a unique code, and a control circuit communicatively coupled to the RFID reader, wherein the control circuit is configured to receive, from a vendor, shipment information for a delivery, associate, with the trailer seal, the delivery, receive, from the RFID reader, an identifier of the RFID tag, generate, based on the identifier of the RFID tag, the unique code, wherein the unique code allows physical access to the distribution center, cause the display device to present the unique code to a mobile device, wherein the mobile device is in possession of an individual associated with the trailer, receive, from the mobile device, an identifier of the mobile device, associate, based on the identifier and the unique code, the delivery with the mobile device, determine, based on the shipment information, instructions for the delivery, and transmit, to the mobile device, the instructions for the delivery.

In some embodiments, an apparatus and a corresponding method performed by the apparatus comprises receiving, from a vendor, shipment information for a delivery, associating the delivery with a trailer seal, wherein the trailer seal includes an RFID tag, and wherein the trailer seal is configured to be affixed to a trailer to prevent unauthorized access to the trailer, reading, by an RFID reader at the distribution center, an identifier of the RFID tag, generating, based on the identifier of the RFID tag, a unique code, wherein the unique code allows physical access to the distribution center, presenting, via a display device, the unique code, receiving, from a mobile device, an identifier of the mobile device, wherein the mobile device is in possession of an individual associated with the trailer, associating, based on the identifier of the mobile device and the unique code, the delivery with the mobile device, determining, based on the shipment information, instructions for the delivery, and transmitting, to the mobile device, the instructions for the delivery.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for automating delivery prioritization at a distribution center, the system comprising:
a trailer seal, wherein the trailer seal includes an RFID tag, and wherein the trailer seal is configured to be affixed to a trailer to prevent unauthorized access to the trailer;
an RFID reader, wherein the RFID reader is located at the distribution center and configured to read RFID tags;
a display device, wherein the display device is configured to present a unique code; and
a control circuit communicatively coupled to the RFID reader, wherein the control circuit is configured to:
receive, from a vendor, shipment information for a delivery;
associate, with the trailer seal, the delivery;
receive, from the RFID reader, an identifier of the RFID tag;
generate, based on the identifier of the RFID tag, the unique code, wherein the unique code allows physical access to the distribution center;
cause the display device to present the unique code to a mobile device, wherein the mobile device is in possession of an individual associated with the trailer;
receive, from the mobile device, an identifier of the mobile device;
associate, based on the identifier of the mobile device and the unique code, the delivery with the mobile device;
determine, based on the shipment information, instructions for the delivery; and
transmit, to the mobile device, the instructions for the delivery.

2. The system of claim 1, wherein the shipment information includes one or more of an indication of items in the delivery, an indication of a retailer, an anticipated arrival date, an anticipated arrival time, and an indication of a destination.

3. The system of claim 1, wherein the control circuit is further configured to:
assign, to the vendor, the trailer seal.

4. The system of claim 3, wherein the control circuit assigns the trailer seal to the vendor by leasing the trailer seal to the vendor.

5. The system of claim 1, further comprising:
the mobile device, wherein the mobile device is configured to:
receive, from the display device, the unique code; and
transmit, to the control circuit, the unique code.

6. The system of claim 1, wherein the display device is one or more of a visual display device and an auditory display device.

7. The system of claim 1, wherein the instructions for delivery are based on a priority determination.

8. The system of claim 7, wherein the priority determination is based on one or more of perishability, stock levels, previous sales, expected sales, expected arrival time of deliveries, and vacancies in the distribution center.

9. The system of claim 1, wherein the instructions for delivery include one or more of a map of the distribution center, a dock number, a time, and a location.

10. A method for automating delivery prioritization at a distribution center, the method comprising:
receiving, from a vendor, shipment information for a delivery;
associating the delivery with a trailer seal, wherein the trailer seal includes an RFID tag, and wherein the trailer seal is configured to be affixed to a trailer to prevent unauthorized access to the trailer;
reading, by an RFID reader at the distribution center, an identifier of the RFID tag;
generating, based on the identifier of the RFID tag, a unique code, wherein the unique code allows physical access to the distribution center;
presenting, via a display device, the unique code;
receiving, from a mobile device, an identifier of the mobile device, wherein the mobile device is in possession of an individual associated with the trailer;
associating, based on the identifier of the mobile device and the unique code, the delivery with the mobile device;
determining, based on the shipment information, instructions for the delivery; and
transmitting, to the mobile device, the instructions for the delivery.

11. The method of claim 10, wherein the shipment information includes one or more of an indication of items in the delivery, an indication of a retailer, an anticipated arrival date, an anticipated arrival time, and an indication of a destination.

12. The method of claim 10, further comprising:
assigning, to the vendor, the trailer seal.

13. The method of claim 12, wherein the assigning, to the vendor, the trailer seal comprises leasing the trailer seal to the vendor.

14. The method of claim 10, further comprising:
receiving, from the mobile device, the unique code; and
transmitting, by the mobile device, the unique code.

15. The method of claim 10, wherein the display device is one or more of a visual display device and an auditory display device.

16. The method of claim 10, wherein the instructions for the delivery are based on a priority determination.

17. The method of claim 16, wherein the priority determination is based on one or more of perishability, stock levels, previous sales, expected sales, expected arrival time of deliveries, and vacancies in the distribution center.

18. The method of claim 10, wherein the instructions for delivery includes one or more of a map of the distribution center, a dock number, a time, and a location.
